(19) United States
(12) Patent Application Publication
(10) Pub. No.: US 2004/0241351 A1
(43) Pub. Date: Dec. 2, 2004

(54) Image recording element with swellable and porous layers

(75) Inventors: Sumana Sharmin, Rochester, NY (US); Sridhar Sadasivan, Rochester, NY (US); Lori Shaw-Klein, Rochester, NY (US); Edwin J. Voll, Rochester, NY (US)

Correspondence Address: Paul A. Leipold, Patent Legal Staff, Eastman Kodak Company, 343 State Street, Rochester, NY, 14650-2201, US

(73) Assignee: Eastman Kodak Company

(21) Appl. No.: 10/447,699

(22) Filed: May 29, 2003

(51) Int. Cl. B41M 5/00

(52) U.S. Cl. 428/32.24

(57) ABSTRACT

The invention provides an image recording element comprising a support and an ink-receiving layer wherein the ink-receiving layer comprises at least one porous layer adjacent the support, and at least one swellable layer adjacent the porous layer and on the surface of the image recording element, wherein the at least one porous layer has pores of a median pore diameter of between 0.05 and 1.0 μm and the at least one swellable layer has a thickness of between 0.5 and 5 μm. The image recording element of the invention is especially useful for ink jet printing.

### FIELD OF THE INVENTION

The present invention relates to an ink jet image recording element with a porous and a swellable coated layer.

### BACKGROUND OF THE INVENTION

In a typical ink jet recording or printing system, ink droplets are ejected from a nozzle at high speed towards an image recording element or medium to produce an image on the image recording element. The ink droplets, or recording liquid, generally comprise a recording agent, such as a dye or pigment colorant, and a large amount of solvent. The solvent, or carrier liquid, typically is made up of water and an organic material such as a monohydric alcohol, a polyhydric alcohol or mixtures thereof.

An ink jet image recording element typically comprises a support having on at least one surface thereof an ink-receiving or image-receiving layer. It is well known that in order to obtain photographic-quality images using an ink jet printer, an ink jet image recording element must:

Exhibit fast ink dry times so that the user may quickly handle and stack the images

Provide long term image stability to the environment, particularly to light and ozone

Provide a reasonable degree of water, stain and abrasion resistance

Exhibit high, uniform gloss

Render superb image quality such as high optical density and sharpness

Have no discontinuities or defects such as cracking, repellencies, comb lines and the like

Ink jet image recording elements that simultaneously provide the aforementioned features have proved difficult to obtain. Even commercially available products exhibit severe deficiencies. Reasons for the difficulties are many; probably the most significant is that ink jet image recording elements must accommodate a wide range of ink compositions and ink volumes that are delivered by today's printers.

Despite the wide variety of ink jet image recording elements known in the art, ink-receiving layers generally are either of two types: swellable (non-porous) or porous. Image recording elements that use swellable layers typically provide good image quality and image stability, but exhibit poor ink dry times. Image recording elements that use porous layers typically exhibit superior ink dry times, but do not provide good image quality or stability.

U.S. Pat. No. 6,238,047 relates to an ink jet recording medium having a porous layer of alumina hydrate formed on a substrate, and a water-soluble resin layer formed as an upper layer thereon. According to the invention described in U.S. Pat. No. 6,238,047, the pores of the porous layer must have a pore radius of from 1 to 30 nm, or 0.001 to 0.03 μm, which is too small to provide fast ink dry time as will be shown herein.

U.S. Pat. No. 6,472,053 B1 relates to an ink jet recording sheet having a support, a first porous ink-receiving layer coated on the support, and a second swellable ink-receiving layer coated on the first ink-receiving layer. The invention is disadvantaged because the particles that can be used in the porous layer are limited to primary particles having an average particle size between 10 to 500 nm.

### PROBLEM TO BE SOLVED BY THE INVENTION

There remains a need for ink jet image recording elements that dry quickly when printed on using aqueous-based ink jet ink compositions at ink laydowns typical of desktop ink jet printers, yet simultaneously provide images having superior image quality and stability to the environment, particularly to the effects of light and ozone. There also remains a need for ink jet image recording elements that exhibit the aforementioned features and are manufactured using readily available materials well known in the art of ink jet printing. In particular, there remains a need for ink jet image recording elements having ink-receiving layers that exhibit the advantages of swellable and porous layers, yet none of their disadvantages.

### SUMMARY OF THE INVENTION

An object of the invention is to provide improved ink jet image recording elements that dry quickly when printed on using aqueous-based ink jet ink compositions at ink laydowns typical of ink jet printers, yet simultaneously provide images having superior image quality and stability to the environment, particularly to the effects of light and ozone.

Another object of the invention is to provide ink jet image recording elements that are manufactured using readily available materials well known in the art of ink jet printing.

A further object of the invention is to provide an ink jet image recording element having ink-receiving layers that exhibit the advantages of swellable and porous layers, yet none of their disadvantages.

The image recording element of the invention provides a support and an ink-receiving layer adjacent the support, wherein the ink-receiving layer comprises at least one porous layer adjacent the support, and at least one swellable layer adjacent to the at least one porous layer and on the surface of the image recording element, wherein the at least one porous layer has pores of a median pore diameter of between 0.05 and 1.0 μm, and the swellable layer has a thickness of between 0.5 and 5 μm.

### ADVANTAGEOUS EFFECT OF THE INVENTION

The invention provides improved ink jet image recording elements for ink jet printing using aqueous-based ink jet ink compositions at ink laydowns typical of ink jet printers. The invention particularly provides ink jet image recording elements that dry quickly after printing and provide photographic-quality images having superior image quality and stability to the environment, particularly to the effects of light and ozone.

### DETAILED DESCRIPTION OF THE INVENTION

The invention has numerous advantages over prior image recording elements used in ink jet printing with aqueous-based inks. The image recording element of the invention dries quickly after printing to form prints that the consumer may readily handle after printing is completed. Fast ink dry times are especially difficult to achieve with ink compositions used in ink jet printers having piezoelectric printheads such as the Stylus® Photo printers commercially available from Epson America, Inc. Ink compositions for piezoelectric printheads have viscosities of up to 8 cP, and as a result they are slow to diffuse into swellable layers or be imbibed by porous layers.

The image recording element of the invention is advantaged over the prior art because it provides printed images with high optical densities, a feature that makes them vibrant and pleasing to the eye. Printed images made therefrom are also advantaged because coalescence (puddling on the surface) is minimized, which gives the images sharpness and observable fine detail. It is well known in the art of inkjet printing that high optical densities are difficult to achieve in combination with coalescence and fast ink dry times.

The image recording element of the invention comprises a support and an ink-receiving layer. The ink-receiving layer comprises at least one porous layer adjacent the support and at least one swellable layer adjacent the porous layer. The at least one swellable layer is located on the surface of the image recording element.

Porous ink-receiving layers useful in the invention consist primarily of particles that are packed in such a way as to give a median pore diameter that facilitates fast ink dry times. Median pore diameter is defined as the median size (50^{th} percentile) of the pores formed between the particles and is measured using the mercury intrusion method. This method is generally well known to those skilled in the art of pore characterization and is essentially carried out by applying hydraulic pressure to a column of mercury in contact with a given weight of the recording element and then measuring the quantity of mercury that is able to intrude into the pores of the recording element. The pressure required to fill the pores is used to calculate the pore diameter, d, using the Washburn equation:

$$d = \frac{( - 4 ) ( σ ) ( cos θ )}{p}$$

where σ is the surface tension of mercury (485 dynes/cm), θ is the contact angle between mercury and the pore surface (assumed to be 130 degrees), and p is the applied pressure.

In an embodiment of the invention, the median pore diameter is between 0.05 and 1.0 μm because porous layers having diameters within this range have been found to give an acceptable combination of image quality and dry time when used according to the invention. In a preferred embodiment, the median pore diameter is between 0.1 and 0.7 μm and especially between 0.2 and 0.5 μm because these ranges provide for a porous layer having increasingly better image quality and ink dry time.

The pore volume for a given area of an image recording element is also determined using the mercury intrusion method described above. The pore volume is simply the volume of mercury that is able to intrude a given area of the image recording element. The pore volume and the median pore diameter together dictate the rate of penetration of the ink into the image recording element. The pore volume necessary to achieve the invention is not particularly limited; pore volumes of at least about 15 cm³/m² have been found to give acceptable performance with the aforementioned median pore diameter ranges.

Any suitable particles may be used in the porous layer of the image recording element of the invention. Examples of particles include calcium carbonate, calcined clay, silica, alumina, boehmite, hydrated alumina, titanium dioxide, zirconium dioxide, inorganic silicates, barium sulfate or organic particles. In a preferred embodiment, calcium carbonate, calcined clay or silica is employed because these materials are inexpensive and readily available.

Particles useful in the porous layer of the image recording element of the invention have a mean particle size that is not particularly limited; mean particle sizes between 0.3 and 5 μm are widely used in the art, and any size within this range should provide acceptable performance in accordance with the invention.

Particles useful in the porous layer of the image recording element of the invention may be non-porous particles, such as calcium carbonate, calcined clay and silica. Useful particles may also be porous particles, such as aggregates of fumed silica and alumina primary particles, or polymeric particles.

The porous layer of the image recording element of the invention also contains a binder. Any suitable binder may be used as long as it is compatible with the aforementioned particles dispersed in an aqueous coating solution. Binders useful in the invention include hydrophilic polymers such as poly(vinyl alcohol), poly(vinyl pyrrolidone), gelatin, cellulose ethers, poly(oxazolines), poly(vinylacetamides), partially hydrolyzed poly(vinyl acetate/vinyl alcohol), poly(acrylic acid), poly(acrylamide), poly(alkylene oxide), sulfonated or phosphated polyesters and polystyrenes, casein, zein, albumin, chitin, chitosan, dextran, pectin, collagen derivatives, collodian, agar-agar, arrowroot, guar, carrageenan, tragacanth, xanthan, rhamsan and the like. In a preferred embodiment, the hydrophilic polymer is poly(vinyl alcohol), a cellulose ether or poly(ethylene oxide) because these polymers are readily available, inexpensive, and compatible in a wide variety of aqueous coating solutions.

Binders useful in the porous layer of the image recording element also include latexes prepared from addition or condensation polymerization reactions, and are well known to those skilled in the art of polymer chemistry. Typical latexes include, but are not limited to, those derived from styrenic, acrylic or acrylate monomers such as poly(styrene-co-butadiene), poly(n-butyl acrylate), poly(n-butyl methacrylate), poly(2-ethylhexyl acrylate), poly(methylmethacrylate-co-butadiene), poly(n-butyl acrylate-co-ethyl acrylate), a copolymer or vinyl acetate and n-butyl acrylate, a copolymer of vinyl acetate and ethylene; polyurethanes; polyesters; or copolymers modified with monomers containing functional groups such as carboxyl groups.

In a preferred embodiment, the latex binder has a Tg value of less than about 100° C., because they tend to prevent cracking of the porous layer. In another preferred embodiment, the latex binder is a poly(styrene-co-butadiene) latex, because these types of latexes tend to be inexpensive and compatible with a wide variety of the aforementioned particles.

The amount of binder used in the porous layer of the image recording element should be sufficient to impart cohesive strength to the layer, but should also be minimized so that it does not significantly alter its porosity, i.e., fill in the pores between the aforementioned particles. Binder may be present in an amount of up to about 20 percent by weight of the porous layer. In a preferred embodiment, the binder is present in an amount of from about 3 to about 8 percent by weight of the porous layer because this range has been found to have little effect on the porosity of the porous layer.

The thickness of the porous layer may be up to about 40 μm and is typically between 10 and 20 μm because this range has been found to give the best overall performance in conjunction with the swellable layer or layers coated thereon.

The swellable layer located on top of the porous layer contains at least one hydrophilic polymer such as a nonionic cellulose ether, an anionic cellulose ether, polyvinyl alcohol, a derivative of polyvinyl alcohol, a polyamide, a sulfonated polyester, a polyvinylpyrrolidone or the like. In a preferred embodiment the swellable layer contains a methyl cellulose such as Methocel® A4M or Methocel® A4C both available from Dow Chemical Co.

The swellable layer may also contain a mordant in an amount of about 1 to about 20 weight percent of the total layer. In the art of ink jet printing, cationic mordants are used in image recording elements because anionic dyes are employed in aqueous ink jet inks. The mordant can be a cationically-modified swellable polymer or a cationic polymeric particle. In a preferred embodiment, the swellable layer contains a cationic cellulose ether because these polymers are highly compatible with the preferred methyl cellulose polymers described above. Examples of cationic cellulose ethers include cationic hydroxyethyl cellulose ethers such as Quatrisoft® LM200 and JR400 both available from Amerchol Corp., and Celquat® SC240C from National Starch and Chemical Co.

Other mordants useful in the swellable layer include cationic polymeric particles in the form of water dispersible polymers, latexes, and beads. Examples of cationic latexes that may be used in the invention include:

a copolymer of (vinylbenzyl)trimethylammonium chloride and divinylbenzene (87:13 molar ratio);

a terpolymer of styrene, (vinylbenzyl)dimethylbenzylamine and divinylbenzene (49.5:49.5:1.0 molar ratio);

a terpolymer of butyl acrylate, 2-aminoethylmethacrylate hydrochloride and hydroxyethylmethacrylate (50:20:30 molar ratio);

a copolymer of styrene, dimethylacrylamide, vinylbenzylimidazole and 1-vinylbenzyl-3-hydroxyethylimidazolium chloride (40:30:10:20 molar ratio);

a copolymer of styrene, 4-vinylpyridine and N-(2-hydroxyethyl)-4-vinylpyridinium chloride (30:38:32 molar ratio); and

a copolymer of styrene, (vinylbenzyl)dimethyloctylammonium chloride), isobutoxymethyl acrylamide and divinylbenzene (40:20:34:6 molar ratio).

The thickness of the swellable layer may range from about 0.5 μm to about 5 μm, preferably from about 0.8 to about 4 μm because this range has been found to provide optimal performance. The swellable layer has an absorption between about 6 and 60 grams of water per gram of the coated layer.

The porous and swellable layer compositions employed in the invention may be applied by any number of well known techniques, including dip-coating, wound-wire rod coating, doctor blade coating, rod coating, air knife coating, gravure and reverse-roll coating, slide coating, bead coating, extrusion coating, curtain coating and the like. Known coating and drying methods are described in further detail in Research Disclosure no. 308119, published December 1989, pages 1007 to 1008. Slide coating is preferred, in which the porous layer and swellable layer may be simultaneously applied. After coating, the layers are generally dried by simple evaporation, which may be accelerated by known techniques such as convection heating.

The support for the ink jet image recording element used in the invention can be any of those usually employed, such as resin-coated paper, paper, polyesters, or microporous materials such as polyethylene polymer-containing material sold by PPG Industries, Inc., Pittsburgh, Pa. under the trade name of Teslin®, Tyvek® synthetic paper (DuPont Corp.), and OPPalyte® films (Mobil Chemical Co.) and other composite films listed in U.S. Pat. No. 5,244,861. Opaque supports include plain paper, coated paper, synthetic paper, photographic paper support, melt-extrusion-coated paper, and laminated paper, such as biaxially oriented support laminates. Biaxially oriented support laminates are described in U.S. Pat. Nos. 5,853,965; 5,866,282; 5,874,205; 5,888,643; 5,888,681; 5,888,683; and 5,888,714. These biaxially oriented supports include a paper support and a biaxially oriented polyolefin sheet, typically polypropylene, laminated to one or both sides of the paper base. Transparent supports include glass, cellulose derivatives, e.g., a cellulose ester, cellulose triacetate, cellulose diacetate, cellulose acetate propionate, cellulose acetate butyrate; polyesters, such as poly(ethylene terephthalate), poly(ethylene naphthalate), poly(1,4-cyclohexanedimethylene terephthalate), poly(butylene terephthalate), and copolymers thereof; polyimides; polyamides; polycarbonates; polystyrene; polyolefins, such as polyethylene or polypropylene; polysulfones; polyacrylates; polyetherimides; and mixtures thereof. The papers listed above include a broad range of papers, from high end papers, such as photographic paper to low end papers, such as newsprint. In a preferred embodiment, polyethylene-coated paper is employed because it gives an image that looks and feels very much like a photograph.

The support used in the invention may have a thickness of from about 50 to about 500 μm, preferably from about 75 to 300 μM because this range tends to give an image having optimal handleability. Antioxidants, antistatic agents, plasticizers and other known additives may be incorporated into the support, if desired.

In order to improve the adhesion of the ink-receiving layer to the support, the surface of the support may be subjected to a corona-discharge treatment prior to applying the image-receiving layer.

In order to impart mechanical durability to an ink jet image recording element, crosslinkers that act upon the binder discussed above may be added in small quantities. Such an additive improves the cohesive strength of the layer. Crosslinkers such as carbodiimides, polyfunctional aziridines, aldehydes, isocyanates, epoxides, polyvalent metal cations, and the like may all be used.

To improve colorant fade, UV absorbers, radical quenchers or antioxidants may also be added to the image-receiving layer as is well known in the art. Other additives include pH modifiers, adhesion promoters, rheology modifiers, surfactants, biocides, lubricants, dyes, optical brighteners, matte agents, antistatic agents, etc. In order to obtain adequate coatability, additives known to those familiar with such art such as surfactants, defoamers, alcohol and the like may be used. A common level for coating aids is 0.01 to 0.30% active coating aid based on the total solution weight. These coating aids can be nonionic, anionic, cationic or amphoteric. Specific examples are described in MCCUTCHEON's Volume 1: Emulsifiers and Detergents, 1995, North American Edition.

The coating composition can be coated either from water or organic solvents, however water is preferred. The total percent weight solids content should be selected to yield a useful coating thickness in the most economical way, and for particulate coating formulations, percent weight solids contents from 10-40% are typical.

Ink jet inks used to image the image recording elements of the present invention are well-known in the art. The ink compositions used in ink jet printing typically are liquid compositions comprising a solvent or carrier liquid, dye or pigment colorants, humectants, organic solvents, detergents, thickeners, preservatives, and the like. The solvent or carrier liquid can be solely water or can be water mixed with other water-miscible solvents such as polyhydric alcohols. Inks in which organic materials such as polyhydric alcohols are the predominant carrier or solvent liquid may also be used. Particularly useful are mixed solvents of water and polyhydric alcohols. The dyes used in such compositions are typically water-soluble direct or acid type dyes. Such liquid compositions have been described extensively in the prior art including, for example, U.S. Pat. Nos. 4,381,946; 4,239,543 and 4,781,758.

Although the image recording elements disclosed herein have been referred to primarily as being useful for ink jet printers, they also can be used as recording media for pen plotter assemblies. Pen plotters operate by writing directly on the surface of a recording medium using a pen consisting of a bundle of capillary tubes in contact with an ink reservoir.

The following example is provided to illustrate the invention.

### EXAMPLE

Element 1 of the Invention

An aqueous-based coating solution for a porous layer was prepared by mixing 100 dry grams of precipitated calcium carbonate Albagloss® S (Specialty Minerals Inc., median particle size 0.6 μm) as a 70% solution, 8.5 dry grams of silica gel Gasil® 23F (Crosfield Ltd., mean particle size 6 μm), 0.5 dry grams of poly(vinyl alcohol) Gohsenol® GH-17 (Nippon Gohsei Co., Ltd.) as a 10% solution, and 5 dry grams of a styrene-butadiene latex CP 692NA (Dow Chemical Co.) as a 50% solution. The final percent weight solids of the coating solution was adjusted to 35% by adding water.

The porous layer coating solution was bead-coated at 25° C. on a base paper, basis weight 185 g/m², and dried at 60° C. by forced air. The thickness of the porous layer was 25 μm.

A coating solution for the swellable layer was prepared by combining 90 dry grams of Goshenol® GH-17 as a 10.6% solution and 10 dry grams of a copolymer of (vinylbenzyl)trimethylammonium chloride and divinylbenzene (87:13 molar ratio) as 14.7% solution. The final percent weight solids of the coating solution was adjusted to 9% by adding water.

The swellable layer coating solution was hand coated on top of the porous layer by using a meier rod. The coated element was then dried at 40° C. to yield an image recording element. The thickness of the swellable layer was 4.5 μm.

Element 2 of the Invention

An aqueous-based coating solution for the porous layer was prepared by mixing 91.7 dry grams of derivatized kaolin Digitex™ 1000 (Engelhard Corp., mean particle size 1-2 μm) as a 70% solution, 4.6 dry grams of Crosfield® 23F, and 3.7 dry grams of poly(vinyl alcohol) Airvol® 325 (Air Products) as a 10% solution. The final percent weight solids of the coating solution was adjusted to 35% by adding water.

The porous layer coating solution was bead-coated at 25° C. on a base paper, basis weight 185 g/m², and dried at 60° C. by forced air. The thickness of the porous layer was 25 μm.

A coating solution for the swellable layer was prepared by combining 90 dry grams of Goshenol® GH-17 as a 10.6% solution and 10 dry grams of a copolymer of (vinylbenzyl)trimethylammonium chloride and divinylbenzene (87:13 molar ratio) as 14.7% solution. The final percent weight solids of the coating solution was adjusted to 9% by adding water.

The swellable layer coating solution was hand coated on top of this porous layer by using a meier rod. The coated element was then dried at 40° C. air to yield a image recording element. The thickness of the swellable layer was 4.5 μm.

Element 3 of the Invention

An aqueous-based coating solution for the porous layer was prepared by mixing 87.7 dry grams of Digitex™ 1000 as a 70% solution, 8.8 dry grams of Crosfield® 23F, and 3.5 dry grams of Airvol® 325 as a 10% solution. The final percent weight solids of the coating solution was adjusted to 35% by adding water.

The porous layer coating solution was bead-coated at 25° C. on a base paper, basis weight 185 g/m², and dried at 60° C. by forced air. The thickness of the porous layer was 25 μm.

A coating solution for the swellable layer was prepared by combining 90 dry grams of Goshenol® GH-17 as a 10.6% solution and 10 dry grams of a copolymer of (vinylbenzyl)trimethylammonium chloride and divinylbenzene (87:13 molar ratio) as a 14.7% solution. The final percent weight solids of the solution was adjusted to 9% by adding water.

The swellable layer coating solution was hand coated on top of the porous layer by using a meier rod. The coated element was then dried at 40° C. to yield an image recording element. The thickness of the swellable layer was 4.5 μm.

Element 4 of the Invention

An aqueous-based coating solution for the porous layer was prepared by mixing 84.0 dry grams of Digitex™ 1000 as a 70% solution, 12.6 dry grams of Crosfield® 23F, and 3.4 dry grams of Airvol® 325 as a 10% solution. The final percent weight solids of the coating solution was adjusted to 35% by adding water.

The porous layer coating solution was bead-coated at 25° C. on a base paper, basis weight 185 g/m², and dried at 60° C. by forced air. The thickness of the porous layer was 25 μm.

A coating solution for a swellable layer was prepared by combining 90 dry grams of Goshenol® GH-17 as a 10.6% solution and 10 dry grams of a copolymer of (vinylbenzyl)trimethylammonium chloride and divinylbenzene (87:13 molar ratio) as a 14.7% solution. The final percent weight solids of the coating solution was adjusted to 9% by adding water.

The swellable layer coating solution was hand coated on top of the base layer by using a meier rod. The coated element was then dried at 40° C. to yield an image recording element. The thickness of the swellable layer was 4.5 μm.

Element 5 of the Invention

An aqueous-based coating solution for the porous layer was prepared by mixing 85.4 dry grams of Albagloss® S as a 70% solution, 7.7 dry grams of Gasil® 23F, 0.7 dry grams of Gohsenol® GH-17 as a 10% solution, and 6.1 dry grams of CP 692NA as a 50% solution. The final percent weight solids of the coating solution was adjusted to 35% by adding water.

The porous layer coating solution was bead-coated at 25° C. on a base paper, basis weight 185 g/m², and dried at 60° C. by forced air. The thickness of the porous layer coating was 25 μm.

A coating solution for the swellable layer was prepared by combining 90 dry grams of Goshenol® GH-17 and 10 dry grams of a copolymer of (vinylbenzyl)trimethylammonium chloride and divinylbenzene (87:13 molar ratio) as 14.7% solution. The final percent weight solids of the coating solution was adjusted to 9% by adding water.

The swellable layer coating solution was hand coated on top of the porous layer by using a meier rod. The coated element was then dried at 40° C. to yield an image recording element. The thickness of the swellable layer was 4.5 μm.

Element 6 of the Invention

An aqueous-based coating solution for the porous layer was prepared by mixing 79.3 dry grams of Albagloss® S as a 70% solution, 14.4 dry grams of Gasil® 23F, 0.7 dry grams of Gohsenol® GH-17 as a 10% solution, and 5.6 dry grams of CP 692NA as a 50% solution. The final percent weight solids of the coating solution was adjusted to 35% by adding water.

The porous layer coating solution was bead-coated at 25° C. on a base paper, basis weight 185 g/m², and dried at 60° C. by forced air. The thickness of the porous layer was 25 μm.

A coating solution for the swellable layer was prepared by combining 90 dry grams of Goshenol® GH-17 as a 10.6% solution and 10 dry grams of a copolymer of (vinylbenzyl)trimethylammonium chloride and divinylbenzene (87:13 molar ratio) as 14.7% solution. The final weight percent solids of the solution was adjusted to 9% by adding water.

The swellable layer coating solution was hand coated on top of the porous layer by using a meier rod. The coated element was then dried at 40° C. to yield an image recording element. The thickness of the swellable layer was 4.5 μm.

Element 7 of the Invention

An aqueous-based coating solution for the porous layer was prepared by mixing 96.5 dry grams of Digitex™ 1000 as a 70% solution and 3.5 dry grams of Airvol® 325 as a 10% solution. The final percent weight solids of the coating solution was adjusted to 35% by adding water.

The porous layer coating solution was bead-coated at 25° C. on a base paper, basis weight 185 g/m², and dried at 60° C. by forced air. The thickness of the porous layer was 25 μm.

A coating solution for the swellable layer was prepared by combining 90 dry grams of Goshenol® GH-17 as a 10.6% solution and 10 dry grams of a copolymer of (vinylbenzyl)trimethylammonium chloride and divinylbenzene (87:13 molar ratio) as 14.7% solution. The final percent weight solids of the solution was adjusted to 9% by adding water.

The swellable layer coating solution was hand coated on top of the porous layer by using a meier rod. The coated element was then dried at 40° C. to yield an image recording element. The thickness of the swellable layer was 4.5 μm.

Element 8 of the Invention

An aqueous-based coating solution for the porous layer was prepared by mixing 79.3 dry grams of Albagloss® S as a 70% solution, 14.4 dry grams of Gasil® 23F, 0.7 dry grams of Gohsenol® GH-17 as a 10% solution, and 5.6 dry grams of a styrene-butadiene latex CP 692NA (Dow Chemical Co.) as a 50% solution. The final percent weight solids of the coating solution was adjusted to 35% by adding water.

The porous layer coating solution was bead-coated at 25° C. on a base paper, basis weight 185 g/m², and dried at 60° C. by forced air. The thickness of the porous layer coating was 25 μm.

A coating solution for the swellable layer was formulated by mixing 30 parts of cationic hydroxy ethyl cellulose Quatrisoft® LM 200 (Amerchol Corp.), 22 parts of methyl cellulose Methocel® A4M (Dow Chemical Co.), 8 parts of Methocel® A4C, and 10 parts of a terpolymer of styrene, (vinyl benzyl)dimethylbenzyl amine, and divinyl benzene (49.5:49.5:1 molar ratio. The final percent weight solids was adjusted to 5% by adding water.

The swellable layer coating solution was hand coated on top of the porous layer by using a meier rod. The coated element was then dried at room 40° C. to yield an image recording element. The thickness of the swellable layer was 0.86 μm.

Element 9 of the Invention

Element 9 has the same structure as Element 8, except that the thickness of the swellable layer was 1.75 μm.

Element 10 of the Invention

Element 10 has the same structure as Element 8, except that the thickness of the swellable layer was 2.1 μm.

Element 11 of the Invention

Element 11 has the same structure as Element 8, except that the thickness of the swellable layer was 2.8 μm.

Element 12 of the Invention

Element 12 has the same structure as Element 8, except that the thickness of the swellable layer was 3.5 μm.

Element 13 of the Invention

Element 13 has the same structure as Element 8, except that the thickness of the swellable layer was 4.5 μm.

Comparative Element 1 (Top Layer is Porous and Not Swellable)

An aqueous-based coating solution for the first porous layer was prepared by combining 88 parts of fumed alumina Cab-O-Sperse® PG003 (Cabot Corp., median aggregate diameter 0.15 μm, primary particle diameter 0.02 μm), 10 parts of poly(vinyl alcohol) Gohsenol® GH-23A, and 2 parts of 2,3-dihydroxy-1,4-dioxane to give an aqueous coating formulation of 30% solids by weight.

A coating solution for the second porous layer was prepared by combining 85 parts of Cab-O-Sperse® PG003, 3 parts of Gohsenol® GH-23A, and 12 parts of a copolymer of (vinylbenzyl)trimethylammonium chloride and divinylbenzene (87:13 molar ratio). Surfactants Zonyl® FSN (E. I. du Pont de Nemours and Co.) and Olin® 10G (Dixie Chemical Co.) were added in small amounts as coating aids.

The above coating solutions were simultaneously bead-coated at 40° C. on polyethylene-coated paper base that had been previously subjected to corona discharge treatment. The coated element was then dried at 60° C. by forced air to yield a coated element in which the thicknesses of the first and second porous layers were 40 μm and 2 μm, respectively.

A coating solution for the swellable layer was prepared by combining 90 dry grams of Goshenol® GH-17 as a 10.6% solution, and 10 dry grams of a copolymer of (vinylbenzyl)trimethylammonium chloride and divinylbenzene (87:13 molar ratio) as 14.7% solution. The final percent weight solids of the coating solution was adjusted to 9% by adding water.

The swellable layer coating solution was hand coated on top of the dried second porous layer by using a meier rod. The coated element was then dried at 40° C. to yield an image recording element. The thickness of the swellable layer was 4.5 μm.

Comparative Element 2 (Swellable Layer Only)

An aqueous-based coating solution for the swellable layer was prepared as described for Comparative Element 1 and hand coated on top of commercially available Epson Photo Quality Glossy Paper (Epson America, Inc.) by using a meier rod. The coated element was then dried at 40° C. to yield an image recording element. The thickness of the swellable layer was 4.5 μm

Comparative Element 3 (Median Pore Diameter Too Small)

An aqueous-based coating solution for the swellable layer was prepared as described for Comparative Element 1 and hand coated on top of commercially available Konica Inkjet Paper QP (Konica Photo Imaging, Inc.) by using a meier rod. The coated element was then dried at 40° C. to yield an image recording element. The thickness of the swellable layer was 4.5 μm.

### Comparative Element 4 (Median Pore Diameter Too Small)

An aqueous-based coating solution for the swellable layer was prepared as described for Comparative Element 1 and hand coated on top of commercially available Mitsubishi IJ RC UF 170C ink jet paper (Mitsubishi Paper Mills, Ltd.) by using a meier rod. The coated element was then dried at 40° C. to yield an image recording element. The thickness of the swellable layer was 4.5 μm.

Testing

Pore Volume and Median Pore Diameter

The pore volume and the median pore diameter for each of the porous layers of the image recording elements described above were measured using Mercury Intrusion Porosimetry. For each image recording element, the measurements were carried out on the coated element consisting of the support and the porous layer(s) after drying, and prior to coating of the swellable layer.

Printing

Test images of cyan, magenta, yellow, red, green and blue patches at 100% ink laydown were printed on the above elements using an Epson Stylus® Photo 870 ink jet printer with a black ink cartridge having catalog number T008 and a color ink cartridge having catalog number T007. After drying for 24 hours at ambient temperature and humidity, the Status A D-max densities were measured using an X-Rite® 820 densitometer.

Image Quality

The image quality was evaluated subjectively. Coalescence refers to the non-uniformity or puddling of the ink in solid filled areas. A subjective rating is used to assess the quality. A coalescence rating of 5 is clearly unacceptable as it has very poor quality and any rating ranging from 1-3 is acceptable.

Dry Time

Immediately after ejection from the printer, a piece of bond paper was placed over the printed image and rolled with a smooth, heavy weight. Then the bond paper was separated from the printed image. The length of the color strip transferred to the bond paper was measured and is proportional to the time needed for the printed image to dry. The dry time is rated as 1 when there is no transfer of the inks to the bond paper, and is considered superior. If the dry time rating is below 3, the quality is considered as acceptable. If there is a full transfer of at least one color strip, the dry time is rated as 5, and is unacceptable.

The following results were obtained:

TABLE 1

| | Pore | Median Pore | | |
|---|---|---|---|---|
| Image Recording | Volume | Diameter | | |
| Element | (cc/m²) | (μm) | Coalescence | Dry Time |
| 1 | 16.6 | 0.16 | 2 | 2 |
| 2 | 20.5 | 0.35 | 3 | 2 |
| 3 | 20.1 | 0.42 | 2 | 2 |
| 4 | 21.3 | 0.37 | 2 | 1 |
| 5 | 20.4 | 0.15 | 3 | 2 |
| 6 | 19.7 | 0.16 | 3 | 2 |
| 7 | 19.2 | 0.49 | 2 | 1 |
| Comparative 1 | 22.0 | 0.030 | 5 | 3 |
| Comparative 2 | 18.5 | 0.018 | 5 | 3 |
| Comparative 3 | 25.6 | 0.022 | 5 | 3 |
| Comparative 4 | 20.3 | 0.021 | 5 | 3 |
| Comparative 5 | 21.9 | 0.020 | 5 | 3 |

The results from Table 1 indicate that the Elements 1 through 7 have better image quality as described by coalescence and dry time compared to Comparative Elements 1 through 5. The Elements 1 through 7 and Comparative Elements 1 through 5 have similar median pore diameters, but the latter have median pore diameters less than 0.05 μm.

Density Testing

Test images of cyan, magenta, yellow, and black patches at 100% ink laydown were printed and after drying for 24 hours at ambient temperature and humidity, the Status A D-max densities were measured using an X-Rite® 820 densitometer. For each of the patch cyan, magenta, yellow and black densities were measured. The following results were obtained:

TABLE 2

| Image | | | | | | |
|---|---|---|---|---|---|---|
| Recording | | Dry | Status A D-max Density | | | |
| Element | Coalescence | Time | Cyan | Magenta | Yellow | Black |
| 9 | 2 | 1 | 2.0 | 1.6 | 1.6 | 1.9 |
| 10 | 3 | 1 | 2.0 | 1.7 | 1.6 | 2.0 |
| 11 | 3 | 1 | 2.0 | 1.7 | 1.7 | 2.0 |
| 12 | 3 | 1 | 2.0 | 1.8 | 1.7 | 2.0 |
| 8 | 2 | 1 | 1.9 | 1.4 | 1.5 | 1.7 |
| 13 | 3 | 3 | 2.0 | 1.8 | 1.7 | 2.0 |

The results in Table 2 indicate that Elements 9 through 12 of the invention have acceptable coalescence, dry time and density.

What is claimed is:

1. An image recording element comprising a support and an ink-receiving layer wherein said ink-receiving layer comprises at least one porous layer adjacent said support and at least one swellable layer adjacent said porous layer and on the surface of said image recording element, wherein said at least one porous layer has pores of a median pore diameter of between 0.05 and 1.0 μm and said at least one swellable layer has a thickness of between 0.5 and 5 μm.

2. An image recording element of claim 1 wherein said at least one porous layer has a median pore diameter of between 0.1 and 0.7 μm.

3. An image recording element of claim 1 wherein said at least one porous layer has a median pore diameter of between 0.2 and 0.5 μm.

4. An image recording element of claim 1 wherein said at least one porous layer comprises particles selected from the group consisting of calcium carbonate, calcined clay, and silica.

5. An image recording element of claim 1 wherein said at least one porous layer comprises particles having a mean particle size of between 0.3 and 5 μm.

6. An image recording element of claim 1 wherein said porous layer comprises a binder.

7. An image recording element of claim 6 wherein said binder comprises poly(vinyl alcohol).

8. An image recording element of claim 6 wherein said binder comprises a latex prepared from addition or condensation polymerization reactions.

9. An image recording element of claim 8 wherein said binder comprises a latex derived from styrenic and/or acrylic monomers.

10. An image recording element of claim 8 wherein said binder has a Tg value of less than about 100° C.

11. An image recording element of claim 6 wherein said binder comprises between 3 and 8 percent by weight of said porous layer.

12. An image recording element of claim 1 wherein said swellable layer has a thickness of between 0.8 and 3.5 μm.

13. An image recording element of claim 1 wherein said swellable layer has an absorption of between 6 and 60 grams of water per gram of the swellable layer.

14. An image recording element of claim 1 wherein said porous layer has a pore volume of at least 15 cm³/m².

15. An image recording element of claim 1 wherein said swellable layer comprises hydrophilic polymer.

16. An image recording element of claim 1 wherein said swellable layer comprises hydrophilic polymer and mordant.

17. An image recording element of claim 16 wherein said mordant comprises a terpolymer of styrene, (vinylbenzyl)dimethylbenzylamine and divinyl benzene in a molar ratio of 49.5:49.5:1.

18. An image recording element of claim 16 wherein said mordant comprises a copolymer of (vinylbenzyl)trimethylammonium chloride and divinylbenzene in a molar ratio of 87:13.

19. An image recording element of claim 1 wherein said swellable layer comprises hydrophilic polymer selected from the group consisting of poly(vinyl alcohol), derivatives of poly(vinyl alcohol), cellulose ethers, polyamides, and mixtures thereof.

20. An image recording element of claim 1 wherein said support comprises cellulose paper.
